(19) United States
(12) Patent Application Publication
(10) Pub. No.: US 2007/0179668 A1
(43) Pub. Date: Aug. 2, 2007

(54) Vending Machine

(76) Inventor: Karl-Heinz Mellin, Dreielch (DE)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/626,836

(22) Filed: Jan. 24, 2007

(30) Foreign Application Priority Data
Jan. 28, 2006 (DE) 20 2006 001 503.5

(51) Int. Cl. G06F 17/00

(52) U.S. Cl. 700/234

(57) ABSTRACT

Vending machine (1) with a housing designed for delivering at least one cosmetic product or a voucher arranged inside the housing:
with at least one dispensing device (6) which feeds the cosmetic product or the voucher from a storage container (7) to a dispensing aperture (5),
with an operating panel (2) for selecting the cosmetic product,
with a presentation region which extends from the outside into the housing and which is configured such that at least one tester of each cosmetic product which is located within the housing or the vouchers thereof located inside the housing may be positioned therein, and thus is accessible from outside in order to use the tester.

The invention relates to a vending machine (display device), which is placed in shops such as supermarkets or chemists and offers the customer the possibility of selecting a specific product, for example a cosmetic product, via an operator interface, and which the customer is then able to remove from the vending machine from a dispensing aperture.

### FIELD OF THE INVENTION

It is known that in the retail market losses as a result of theft, in particular for cosmetic products, are extremely high. The cosmetic products openly offered for sale in large quantities obviously tempt thieves, in particular, to steal such products in similarly large quantities. There is, therefore, an urgent need to stop this theft but at the same time to ensure that the customer is nevertheless still able to test cosmetics which are of interest. Thus it has to be ensured that the customer, on the one hand, is able to pick up and try out an individual tester but on the other hand stealing a larger number of cosmetic products is made impossible.

### OVERVIEW OF THE INVENTION

This object is achieved by a vending machine/display device 1 which is provided with at least one dispensing device 6 for delivering individual items and which feeds the individual items to a dispensing aperture 5 as well as to an operating panel for product selection 2. By means of the operating panel for product selection 2, which is expediently designed as a flat screen, the customer is able to enter the data required to identify the selected individual item, by means of which the dispensing of the selected product and the delivery thereof to the dispensing aperture 5 is triggered.

The vending machine according to the invention which is particularly suited to dispensing cosmetics and/or toiletries has, positioned on its outer face which is easily accessible to the customer, one respective individual product of the products stored inside the vending machine which the customer is able to try out directly on their own body relative to the aroma, colour and other properties. Every individually displayed product is identified by a code number or in any other suitable manner. As soon as the customer has found a product which suits, by pressing a button or in any other suitable manner, the customer is able to enter into the operating panel 2 the data required to identify the selected product which is then fed to the customer immediately via the dispensing aperture 5.

It is particularly advantageous if the vending machine according to the invention is also fitted with a device for providing product advice, which expediently might consist of a screen, a loudspeaker and/or a camera. As a result, it is possible that, when selecting the cosmetic or toiletry, the customer is not left alone but, on request and at any time, is able to receive the necessary sales information via the device for providing product advice. Expediently, the device for providing product advice might be linked to the operating panel for product selection 2, so that the product is an advice is immediately and automatically provide when a selection for a product is entered into the operating panel 3, so that the customer is able to remove the goods immediately from the vending machine and further getting information about the product.

The vending machine may advantageously be controlled in such a manner from any point of the sales area, for example from the till, without it being necessary for the trained personnel to have to come to the vending machine. In this connection, the vending machine may be controlled from a greater distance, either by means of an electrical connection or by a radio signal.

In certain cases, it may also be expedient to use a vending machine according to the invention which dispenses not the desired goods but a corresponding voucher. This is expedient whenever the desired goods are no longer available in the machine and are not able to be re-stocked rapidly enough or when faults have occurred in the dispensing device.

For correct functioning of the vending machine according to the invention, it is naturally desirable to have a permanent accurate overview of the number of stock items still present therein. A recording unit might, therefore, be provided which records and stores the number of dispensed items, as well as forwards the respective filled state of the vending machine to a central point, from which the re-stocking or possible re-ordering of the product may be undertaken. It is particularly expedient to provide the recording unit with a read-out apparatus which, for each radio transmission, forwards the respective filled state to an external receiver.

The vending machine according to the invention, therefore, has the advantage that the customer is able to try out the desired product but the actual merchandise is stored within the vending machine invisible to the customer and only dispensed when the customer has made a choice. At the same time, the vending machine according to the invention also allows the provision of specific product advice in which the specialist personnel working at a more remote point of the sales area are able to make contact with the customer via a screen, loudspeaker and/or camera and provide advice according to the individual requirements of the customer.

### BRIEF DESCRIPTION OF THE FIGURES

The vending machine according to the invention is shown in detail by the accompanying FIG. 1 to FIG. 3.

FIG. 1 shows a dispensing machine according to the invention with an operating panel 2 designed as a screen and a camera 3. Furthermore, surfaces are provided for positioning or adjusting the testers 4. The dispensing aperture 5 for the selected goods may be seen in the lower part of the vending machine.

FIG. 2 shows a dispensing device 6 and a storage container 7.

FIG. 3 shows the dispensing aperture for the selected goods.

### DETAILED DESCRIPTION OF THE FIGURES

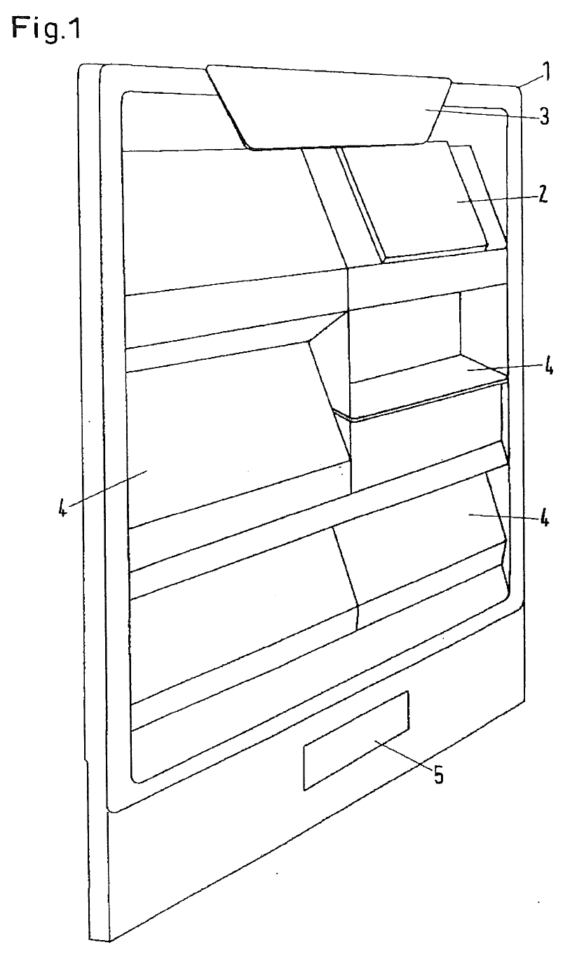

In FIG. 1 a vending machine is disclosed with a housing which comprises a row of surfaces for positioning or adjusting testers. This surface may be designed as compartments, may have been integrated as drawers or be ramp-shaped with a plurality of bores or recesses in which products are arranged in a step-like manner, with a presentation region which extends from the outside into the housing and which is configured such that at least one tester of each cosmetic product which is located inside the housing or the vouchers thereof located inside the housing, may be placed therein and thus be accessible from the outside in order to use the tester. Further it is possible that a sensor measures, that a good as been removed for the presentation area and selection number or field assigned to the good is presented or highlighted in the display, so that an immediate choice can be performed, just be confirming the selection number or field.

The vending machine is preferably configured to be secure against vandalism and allows the controlled delivery of at least one cosmetic product or a voucher arranged inside the housing. Furthermore, it is ensured that a defined number of products are only dispensed in a specific time period, in order to prevent theft from the vending machine.

Via an operating panel 2, the user enters the product which he/she would like to be dispensed or selects information about the product which is to be given, either acoustically or visually. Important usage information and application information may be provided before the dispensing of the product to the interested party so that the product is used correctly thereby. Liability problems can be prevented in this way. The device for providing product advice is also linked to the operating panel for product selection, so that information is given for the selected product or the product is dispensed and, simultaneously, information about the selected product is given.

In the preferred embodiment, the device for providing product advice consists of a screen and loudspeaker and a camera may also be used.

In a preferred embodiment, the dispensing of the product is only able to be activated by the till personnel. In this connection, the vending machine is controlled from an external point, preferably from sales till, information about the selection being transmitted to the sales till, and only then the dispensing being activated there, preferably after direct visible contact or by using the camera in the vending machine. The vending machine is, therefore, controlled by means of an electrical connection or by means of a radio signal.

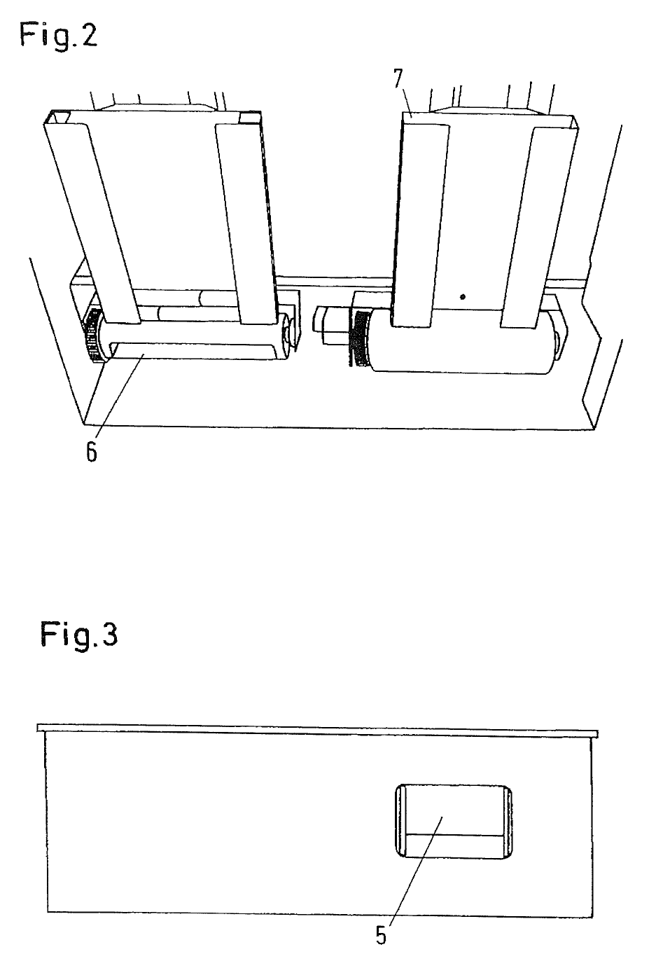

The cosmetic product or the voucher is fed from a storage container 7 to a dispensing aperture 5 via a dispensing device 6 which is disclosed in FIG. 2.

In a preferred embodiment, fastening means are present in order to secure the testers, so that the testers are only able to be used in a specific region. In this connection fastening means such as eyelets and a strap are used, the strap being connected to the tester and the eyelet being formed on the vending machine in which the strap is also fastened. The user may, therefore, use the tester only in a restricted radius. It is also conceivable to provide the product with a transmitter which triggers an alarm when it is moved too far away. The products are registered, for example, via an RFID tag which is continually read. If the tag is no longer readable for a specific time period, an alarm is triggered. Furthermore an alarm can be trigged when the sensor, described above, indicates that the tester has been removed for a longer period.

The removal system is visible in FIGS. 2 and 3.

The dispensing device 6 is configured as a rotatably driven tube which is arranged below a storage container 7. The outer skin of the tube is partially removed to form an aperture so that a product is able to fall into the inside of the tube out of the storage container, if the aperture is arranged below the storage container, and by rotating the tube the product falling out of the aperture and being moved in the direction of the dispensing aperture. The diameter of the tube is configured such that only one respective product is able to fall. The apertures and the space within the tube may be set to be variable so that different products are able to be used. This may be carried out by changing the tube or by caps which are pushed over the apertures and by inserts in the tube.

In a preferred embodiment, a conveyor belt is arranged below the tube which transports the product to the removal aperture 5.

The disclosed embodiments do not serve to restrict the invention but have the purpose of making the invention more comprehensible. The scope of the patent is exclusively determined by the following claims and the widest interpretation thereof.

### LIST OF REFERENCE NUMERALS

1 Vending machine
2 Operating panel for product selection
3 Camera
4 Surfaces for positioning or adjusting the testers
5 Dispensing aperture
6 Dispensing device
7 Storage container

1. A vending machine with a housing designed for delivering at least one cosmetic product or a voucher arranged inside the housing, comprising:
at least one dispensing device which feeds the cosmetic product or the voucher from a storage container to a dispensing aperture,
an operating panel for selecting the cosmetic product,
a presentation region which extends from the outside into the housing and which is configured such that at least one tester of each cosmetic product which is located within the housing or the vouchers thereof located inside the housing may be positioned therein, and thus is accessible from outside in order to use the tester.

2. The vending machine as claimed in claim 1, fastening means being present in order to secure the testers, so that the testers are only able to be used in a specific region.

3. The vending machine as claimed in claim 2, the fastening means being eyelets and a strap, the strap being connected to the tester and the eyelet being formed on the vending machine in which the strap is also fastened.

4. The vending machine as claimed in claim 1, the vending machine comprising a device for providing product advice consisting of a screen, loudspeakers and/or a camera.

5. The vending machine as claimed in claim 4, the device for providing product advice being linked to the operating panel for product selection, so that information is given for the selected product or the product is dispensed and, simultaneously, information about the selected product is given.

6. The vending machine as claimed in claim 1, the vending machine being controlled from an external point, preferably from a sales till, information about the selection being transmitted to the sales till, and only then the dispensing being activated there.

7. The vending machine as claimed in claim 6, the vending machine being controlled by means of an electrical connection or by a radio signal.

8. The vending machine as claimed in claim 1, the vending machine comprising a recording unit which records and stores the number of individual items delivered.

9. The vending machine as claimed in claim 8, the data of the recording unit being able to be read, preferably by radio transmission to an external receiver.

10. The vending machine as claimed in claim 1, the dispensing device being configured as a rotatably driven tube, which is arranged below a storage container, the outer skin thereof being partially removed to form an aperture so that a product is able to fall into the inside of the tube out of the storage container, if the aperture is arranged below the storage container, and by rotating the tube the product falling out of the aperture and being moved in the direction of the dispensing aperture.

11. The vending machine as claimed in claim 11, a conveyor belt being arranged below the tube which transports the product to the dispensing aperture.

12. The vending machine as claimed in claim 1, comprising a sensor measuring the removal of a tester, triggering that in the selection number or field assigned to the good is presented or highlighted in the operating panel, so that an immediate choice can be performed, just be confirming the selection number or field.
